(19) United States
(12) Patent Application Publication
(10) Pub. No.: US 2020/0276756 A1
(43) Pub. Date: Sep. 3, 2020

(54) APPARATUS AND METHOD FOR THREE DIMENSIONAL PRINTING OF AN INK

(71) Applicant: Nanyang Technological University, Singapore (SG)

(72) Inventors: Yannapol SRIPHUTKIAT, Singapore (SG); Yufeng ZHOU, Singapore (SG)

(21) Appl. No.: 16/753,753

(22) PCT Filed: Nov. 23, 2018
(86) PCT No.: PCT/SG2018/050575

§ 371 Date: Apr. 3, 2020

(30) Foreign Application Priority Data
Nov. 24, 2017 (SG) 10201709717Q

(51) Int. Cl. B29C 64/209; B29C 64/165; B33Y 70/00

(52) U.S. Cl. CPC B29C 64/209; B33Y 30/00; B33Y 70/00; B29C 64/165

(57) ABSTRACT

An apparatus for three dimensional printing of an ink comprising microparticles suspended in a printing medium, the apparatus comprising: a tubular nozzle with a tapered tip having an outlet for dispensing the ink therethrough; a first acoustic transducer provided on the nozzle to produce a first structural vibration in the nozzle at a first frequency; and a second acoustic transducer provided on the nozzle to produce a second structural vibration in the nozzle at a second frequency, the first frequency being higher than the second frequency; wherein when the ink is being dispensed through the nozzle, the first structural vibration accumulates microparticles in longitudinal streamlines at pressure nodes created in the printing medium, and the second structural vibration aligns the accumulated microparticles in the longitudinal streamlines towards a single central streamline in the printing medium in the direction of the outlet.

### FIELD

This invention relates to an apparatus and method for three dimensional printing of an ink.

### BACKGROUND

Distribution of particles in multiphase materials (i.e. solid particles/cells suspended in a liquid) such as an ink comprising microparticles suspended in a printing medium is random. Thus, a main challenge of three dimensional (3D) printing of such inks is to precisely locate or focus microparticles (such as cells, protein molecules etc.) in the ink onto the printing structure. Focusing cells in the 3D printed structure could potentially improve the load distribution [1], mechanical performance [2] and detection efficiency [3] of the printed structure. However, existing methods of microparticle focusing for 3D printing have limitations. For instance, a magnetic force [9, 10, 13] could align microparticle orientation at the interface [11]. But this method requires labelling the cells proteins with magnetic nanoparticles, which is usually time-consuming and the resulting printed structure when used in the human body may cause some toxicity [12]. Similarly, using electricity to manipulate conductive and/or dielectric microparticles also requires the microparticles to have certain electrical charge properties [1, 13, 14]. However, the high electric field may induce heating, which may affect the viability of mammalian cells.

Another common problem when using 3D printers and other high-resolution machines is nozzle clogging, which results in loss of time, budget, productivity, non-uniformity, and defect on the printed part. Nozzle clogging is mainly due to deposition/agglomeration of particles at the constriction region of the nozzle (typically tapered), which affects accuracy, reliability of printing and printable material in selection [47-49]. In the printing of inks that comprise bioinks, use of surfactants to reduce clogging by modifying the surface tension of the ink introduces other problems such as decreased cell viability and proliferation in the long-term for bioprinting [50]. Also, the surfactant could change the physical properties such as stiffness, which may lead to the printed part being unable to maintain the 3D structure. Furthermore, only a small range of the surface tension could be reduced, depending on the type of fluid, substrate and surfactant [51].

While it is also desirable to manipulate patterning of microparticles or cells in the printed structure in order to improve functionality and efficiency of the printed structure, the currently known method of acoustic focusing of the microparticles can only improve the alignment of microparticles after being printed [13]. This is achieved by attaching transducers to the side wall of the printing stage onto which the ink is deposited, in order to establish standing bulk acoustic waves to manipulate microparticles that have been deposited on the printing stage. However, acoustic focusing is limited to the pattern of bulk standing waves in the printing stage, which is not easily controllable. Furthermore, the excitation area is large and, as a result, high acoustic power is required, which leads to heat accumulation that may affect thermal sensitive materials and harm biological cells. Also, this method can only be used for a few types of materials which require chemical or UV irradiation to crosslink/solidify the ink after being printed.

### SUMMARY

This application discloses a 3D printing apparatus and method to manipulate an ink comprising a suspension of microparticles (such as cells) in a printing medium for additive printing of the microparticles without clogging a tubular nozzle of the apparatus, wherein the ink has a defined flow path and the microparticles are dispensed from the nozzle in an aligned manner. Using two acoustic transducers, a high frequency structural vibration provides greater acoustic radiation force to the microparticles to rapidly gather them to the pressure nodes created in the printing medium while a low frequency structural vibration “squeezes” or aligns the microparticles streams at the pressure nodes into a single central line in the printing medium towards an outlet of the nozzle. In this way, ultrafast manipulation of the microparticles may be achieved, allowing the 3D printing to be performed at a high flow rate. Concentration of microparticles may range from being relatively diluted (0.1% w/w) to relatively dense (>2% w/w) in the ink. Acoustic excitation of the ink as it is dispensed through the nozzle also results in a significant reduction of microparticle accumulation at the nozzle tip and, accordingly, a significant reduction of nozzle clogging/blockage.

Distribution of the microparticles in the printing structure closely follows the focused pattern in the nozzle and can be easily controlled by modifying excitation frequencies of the nozzle for different structural vibration modes. With this flexibility, accumulation of microparticles on the printing structure may be controlled (e.g. single straight line at the centre, two lines, three lines, etc. As focusing of microparticles occurs in the nozzle, the focused microparticle stream can be freely printed following the trace of the nozzle. Hence, the microparticles can be focused on three-dimensional printing structures. This approach allows great flexibility to construct 3D printing structures with the controllable alignment of the microparticles.

Furthermore, as the acoustic excitation region is small, focusing of the microparticles can be achieved at low power. Heat generated by the transducers is low and fluid flow is also able to transfer excess heat from the excitation region continuously so that thermal effect on the printing medium is negligible. This is important for cell printing as elevated temperatures may have an adverse effect on cell morphology and viability. The present approach may make use of synchronization of dual multiple excitations to significantly speed up accumulation of the microparticles in the nozzle. Different inks may be printed using the present apparatus and method if the properties of the microparticles (i.e., density and compressibility) are different from those of the printing medium.

According to a first aspect, there is provided an apparatus for three dimensional printing of an ink comprising microparticles suspended in a printing medium, the apparatus comprising: a tubular nozzle with a tapered tip having an outlet for dispensing the ink therethrough; a first acoustic transducer provided on the nozzle to produce a first structural vibration in the nozzle at a first frequency; and a second acoustic transducer provided on the nozzle to produce a second structural vibration in the nozzle at a second frequency, the first frequency being higher than the second frequency; wherein when the ink is being dispensed through the nozzle, the first structural vibration accumulates microparticles in longitudinal streamlines at pressure nodes created in the printing medium, and the second structural vibration aligns the accumulated microparticles in the longitudinal streamlines towards a single central streamline in the printing medium in the direction of the outlet.

The second acoustic transducer may be provided downstream of the first acoustic transducer between the first acoustic transducer and the tapered tip.

The first acoustic transducer and the second acoustic transducer may be collinear on the nozzle.

According to a second aspect, there is provided a method of three dimensional printing of an ink comprising microparticles suspended in a printing medium, the method comprising the steps of:

(a) dispensing the ink through an outlet of a tubular nozzle with a tapered tip;

(b) producing a first structural vibration in the nozzle at a first frequency to accumulate microparticles in longitudinal streamlines at pressure nodes created in the printing medium; and

(c) producing a second structural vibration in the nozzle at a second frequency to align the accumulated microparticles in the longitudinal streamlines towards a single central streamline in the printing medium in the direction of the outlet, the first frequency being higher than the second frequency.

Step (b) may comprise providing a first acoustic transducer on the nozzle and exciting the first acoustic transducer at the first frequency and step (c) may comprise providing a second acoustic transducer on the nozzle and exciting the second acoustic transducer at the second frequency.

For both aspects, the first frequency and the second frequency may be different multiples of a fundamental frequency.

For both aspects, the first frequency may be a higher order frequency relative to the second frequency.

For both aspects, the first structural vibration and the second structural vibration may be perpendicular to a flow path of the ink in the nozzle

For both aspects, the first frequency may be a third harmonic and the second frequency may be a fundamental frequency.

For both aspects, the second frequency and the first frequency may be supplied to the acoustic transducer at a power ratio of 9 to 1.

### BRIEF DESCRIPTION OF FIGURES

In order that the invention may be fully understood and readily put into practical effect there shall now be described by way of non-limitative example only exemplary embodiments of the present invention, the description being with reference to the accompanying illustrative drawings.

FIG. 1 is a schematic illustration of an exemplary embodiment of an apparatus for 3D printing of an ink.

FIG. 2 is a flowchart of an exemplary embodiment of a method of 3D printing of an ink.

FIG. 3 is a cross-sectional illustration of subdomains and boundary conditions in an FEM simulation of an apparatus for 3D printing of an ink.

FIG. 4(a) is a schematic diagram of an experimental set-up to observe motion of microparticles along a tubular nozzle for 3D printing of an ink.

FIG. 4(b) is a schematic diagram of an experimental set-up to observe motion of microparticles across a tubular nozzle for 3D printing of an ink.

FIG. 4(c) is a representative photograph of accumulated microparticles in a glass tubular nozzle for 3D printing of an ink.

FIG. 5 is a graph showing change of peak light intensity during microparticle accumulation in a printing medium in a glass tubular nozzle with 1% alginate and varied microparticle concentrations.

FIG. 6(a) is a representative photo of microparticles in a glass tubular nozzle with 1% sodium alginate and 0.25% microparticle before acoustic excitation.

FIG. 6(b) is a representative photo of microparticles in a glass tubular nozzle with 1% sodium alginate and 0.25% microparticle after acoustic excitation.

FIG. 6(c) is a graph of distribution of normalized light intensity in a glass tubular nozzle with 1% sodium alginate and 0.25% microparticle before acoustic excitation,

FIG. 6(d) is a graph of distribution of normalized light intensity in a glass tubular nozzle with 1% sodium alginate and 0.25% microparticle after acoustic excitation.

FIG. 7(a) shows simulated radial stress in kPa of a glass tubular nozzle at the excitation 2.0 frequency of 168 kHz.

FIG. 7(b) is a polar plot showing simulated (172 kHz) and measured (168 kHz) normalized vibration velocity.

FIG. 7(c) shows time-averaged acoustic pressure in kPa a glass tubular nozzle at 168 kHz.

FIG. 7(d) shows simulated locations of 50-μm microparticles after 0.2 seconds of excitation.

FIG. 7(e) is a cross-sectional image of microparticles in a glass tubular nozzle without acoustic excitation.

FIG. 7(f) is a cross-sectional mage of microparticles in a glass tubular nozzle with acoustic excitation.

FIG. 8(a) is a graph of accumulation time and width of microparticles in the solution with 1%, 2%, 3%, and 4% sodium alginate and 0.25% microparticles (n=6 for each condition).

FIG. 8(b) is a graph of accumulation time and width of microparticles in the solution with 0.25%, 0.5%, 1.0%, 1.5%, and 2.0% microparticles and 1% sodium alginate (n=6 for each condition).

FIG. 9(a) shows printing structures with 2% sodium alginate and 0.5% microparticle on the petri dish printed without and with acoustic excitation.

FIG. 9(b) shows a close-up of the printing structure without acoustic excitation during printing.

FIG. 9(c) shows a close-up of the printing structure with acoustic excitation during printing.

FIG. 10(a) is a graph showing a histogram (solid line) and fitted Gaussian curve (dashed line) of microparticle distribution in the printing structure using the ink with 1% sodium alginate and 0.5% microparticle without acoustic excitation.

FIG. 10(b) is a graph showing Histogram (solid line) and fitted Gaussian curve (dashed line) of microparticle distribution in the printing structure using the ink with 1% sodium alginate and 0.5% microparticle with acoustic excitation.

FIG. 10(c) is a graph comparing distributed microparticle width at the various sodium alginate concentration from 1% to 4% and microparticle concentration of 0,%, *: statistically different between the experimental data without and with the acoustic excitation (p<0.05).

FIG. 10(d) is a graph comparing distributed microparticle width at the sodium alginate concentration of 1% and various microparticle concentrations from 0.25% to 2%, *: statistically different between the experimental data without and with the acoustic excitation (p<0.05).

FIG. 11(a) is a simulated acoustic pressure field in kPa in the cross-section of a glass tubular nozzle at 393 kHz.

FIG. 11(b) shows simulated location of accumulated microparticles in the cross-section of a glass tubular nozzle at 393 kHz.

FIG. 11(c) is a representative photograph of accumulated microparticles in the cross-section of a glass tubular nozzle at 393 kHz.

FIG. 11(d) is a representative photograph of accumulated microparticles in the printing structure at 393 kHz.

FIG. 11(e) is a representative photograph of accumulated microparticles along a glass tubular nozzle at 393 kHz.

FIG. 11(f) is a graph showing a histogram and fitted Gaussian curves for each accumulation line under acoustic excitation at 385 kHz.

FIG. 12(a) is a simulated acoustic pressure field in kPa in the cross-section of a glass tubular nozzle at 563 kHz.

FIG. 12(b) shows simulated location of accumulated microparticles in the cross-section of a glass tubular nozzle at 563 kHz.

FIG. 12(c) is a representative photograph of accumulated microparticles in the cross-section of a glass tubular nozzle at 56 kHz.

FIG. 12(d) is a representative photograph of accumulated microparticles in the printing structure at 563 kHz.

FIG. 12(e) is a representative photograph of accumulated microparticles along a glass tubular nozzle at 563 kHz.

FIG. 12(f) is a graph showing a histogram and fitted Gaussian curves for each accumulation line under acoustic excitation at 63 kHz.

FIG. 13 is a schematic diagram of an experimental setup to align/accumulate microparticles in a glass tubular nozzle and print on on a platform.

FIG. 14(a) is a photograph of fibroblast L929 cells in a printing structure printed without acoustic excitation.

FIG. 14(b) is a photograph of fibroblast L929 cells in a printing structure printed with acoustic excitation.

FIG. 15(a) shows microparticle distribution at an excitation frequency of 899 kHz in the cylindrical tube of a glass tubular nozzle without acoustic excitation.

FIG. 15(b) shows microparticle distribution at an excitation frequency of 899 kHz in the cylindrical tube of a glass tubular nozzle with acoustic excitation.

FIG. 15(c) shows microparticle distribution at an excitation frequency of 899 kHz in the tapered tip of a glass tubular nozzle without acoustic excitation.

FIG. 15(d) shows microparticle distribution at an excitation frequency of 899 kHz in the tapered tip of a glass tubular nozzle with acoustic excitation.

FIG. 16(a) is a graph of accumulation area with and without acoustic excitation at the alginate concentration of 1%.

FIG. 16(b) is a graph of accumulation area with and without acoustic excitation at the alginate concentration of 2%.

FIG. 16(c) is a graph of accumulation area with and without acoustic excitation at the alginate concentration of 3%.

FIG. 17(a) is a graph of amount of printing medium discharged from the nozzle with and without acoustic excitation at the alginate concentration of 1%.

FIG. 17(b) is a graph of amount of printing medium discharged from the nozzle with and without acoustic excitation at the alginate concentration of 2%.

FIG. 17(c) is a graph of amount of printing medium discharged from the nozzle with and without acoustic excitation at the alginate concentration of 3%.

### DETAILED DESCRIPTION

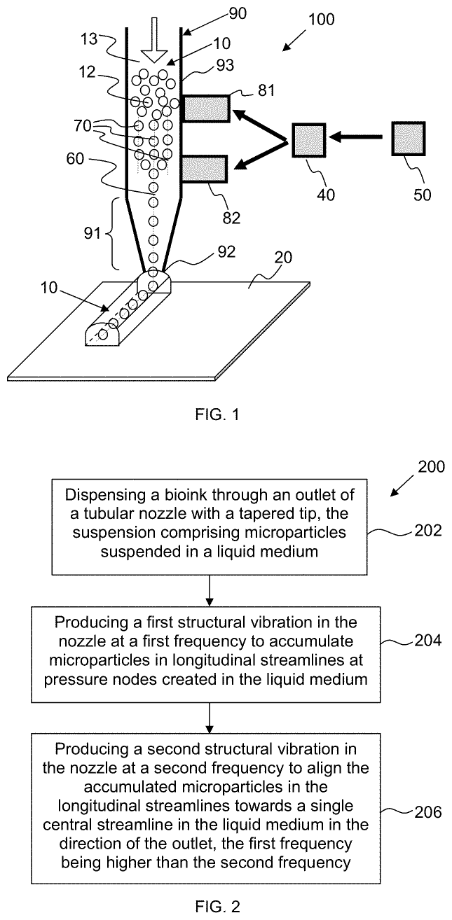

Exemplary embodiments of an apparatus 100 and method 200 for three dimensional (3D) printing of an ink will be described below with reference to FIGS. 1 to 17, in which the same reference numerals are used to refer to the same or similar parts.

As shown in FIG. 1, in an exemplary embodiment, the apparatus 100 for 3D printing of an ink 10 comprises a tubular nozzle 90 with a tapered tip 91 having an outlet 92 for dispensing the ink 10 therethrough onto a substrate 20. The ink 10 comprises microparticles 12 suspended in a printing medium 13. The apparatus 100 also comprises a first acoustic transducer 81 provided on the nozzle 90 to produce a first structural vibration at the first frequency and a second acoustic transducer 82 provided on the nozzle 90 to produce a second structural vibration at the second frequency.

The second acoustic transducer 82 is provided on the nozzle 90 downstream of the first acoustic transducer 81, between the first acoustic transducer 81 and the tapered tip 91. Preferably, the first acoustic transducer 81 and the second acoustic transducer 82 are collinear on the nozzle 90. Orientation of the acoustic transducers 81, 82 is preferably but not necessarily parallel to direction of fluid flow (indicated by the white arrow in FIG. 1) in the nozzle 90.

The acoustic transducers 81, 82 are preferably attached to a cylindrical portion 93 of the nozzle 90, upstream of the tapered tip 91. Material of the nozzle 90, diameter of the cylindrical portion 93, and geometry or shape of the tapered tip 91 (which provides a smooth constriction from the cylindrical portion 93 to the outlet 92) may be appropriately adapted to suit different inks without being limited to a specific configuration. Similarly, the actual location and orientation of the transducers 81, 82 and also the distance between the transducers 81, 82 may be appropriately adapted to suit different inks without being limited to a particular configuration. A function generator with power amplifier 50 may be provided to excite the transducers 81, 82. An impedance matching unit 40 may be provided to match the electrical impedance for each transducer 81, 82 in order to enhance electrical-to-acoustic energy conversion. Preferred impedance is dependent on the specification of the power amplifier 50 used according to the impedance matching theorem.

The first frequency is higher than the second frequency. Preferably, the first and second frequencies are synchronised. Further preferably, the first frequency and the second frequency are different multiples of a fundamental frequency. The first frequency is preferably in higher orders. For example, the first frequency may be the third harmonic and the second frequency may be the fundamental frequency. The second frequency and the first frequency may be supplied to the acoustic transducer at a power ratio of 9 to 1.

The first structural vibration and the second structural vibration are perpendicular to the flow path (indicated by the white arrow) of the ink 10 in the nozzle 90. Using the apparatus 100, in the method 200 of printing as shown in FIG. 2, when the ink 10 is being dispensed through the nozzle 90 (202), producing the first structural vibration in the nozzle 90 at the first frequency (204) accumulates microparticles 12 in longitudinal streamlines 70 at pressure nodes created in the printing medium 13, while producing the second structural vibration in the nozzle 90 at the second frequency (206) aligns the microparticles 12 accumulated in the longitudinal streamlines 70 towards a single central streamline 60 in the printing medium 13 in the direction of the outlet 92.

The aim of dual-frequency excitation is to speed up the accumulation time of microparticles/cells toward the centre or desired streamline. To choose excitation frequencies, pairs of f₁ & f₃, f₁ & f₅ and f₃ & f₅ are recommended, but not limited to, where f₁, f₃, and f₅ are the fundamental, the third- and the fifth-harmonic, respectively. The dual/multiple-frequency excitation may be implemented by having a high frequency applied to the upper transducer 81 while a low frequency is applied to the lower transducer 82. The key is to accumulate microparticles/cells in the ink 10 to form lumps under the high frequency. Afterwards, the low frequency is excited to move the lumps of microparticles/cells towards the centre streamline 60 more effectively. Thus, the accumulation time could be reduced up to 82% from numerical simulation for the two transducers 81, 82.

As a general guide, the relationship between the inner diameter of the cylindrical tube 93 of the nozzle 90, excitation frequency, and recommended thickness of a piezo plate that is used as the transducers 81, 82 is as shown in Table 1 below:

TABLE 1

| Tube inner | Estimated | Recommended |
|---|---|---|
| diameter | fundamental and higher | thickness of piezo |
| (mm) | orders frequency (kHz) | plate (mm) |
| 1.2 | 899, 1935, 3532 | 2.29 |
| 2.64 | 396, 880, 1605 | 5.06 |
| 6.8 | 162, 385, 657 | 12.3 |

k_{g} = Tube ID × excitation frequency
where k_{g} ≈ 1.07 mm · kHz for a pyrex glass tube

Recommended parameters that may be used in the apparatus 100 and method 200 are:
Power applied in a range of 0.3-1.2 Watt to avoid heat accumulation
The first transducer 81 is preferably excited at high frequency with at least one pressure node of structural vibration mode in the cross-section of the cylindrical tube 93 of the nozzle 90. For the second transducer 82, the fundamental mode (dipole mode is recommended)
The target value for impedance is 50Ω±0 j for the input impedance of a general purpose power amplifier with the output impedance of 50Ω. Other power amplifiers may have the impedance of 8Ω or 4Ω
Various waveforms can be used (e.g. sinusoidal wave, square wave, and pulsed wave)

Depending on the actual magnitude of the first and second frequencies, various patterns of microparticle distribution and accumulation in the printing medium 13 in the nozzle 90 can be obtained, as will be described in greater detail below in the experimental studies conducted to verify the apparatus 100 and method 200.

### Experimental Study of Low Frequency Bipolar Mode of Structural Vibration

In this study, a low frequency bipolar mode of structural vibration of a cylindrical tube having a tapered tip (representing the nozzle 90 of the apparatus 100) was used to concentrate microparticles at the centre of the tube and subsequently on the printing structure. The effects of experimental parameters, such as the concentration of microparticles and sodium alginate (the printing medium) on the printing were studied. The fluid viscosity of the ink containing microparticles is an important factor for extrusion printing [25, 26].

A numerical simulation was first carried out to predict the excitation frequency, structural vibration, and distribution of acoustic pressure in a cylindrical tube, and the corresponding accumulation of microparticles therein. The experimental excitation frequency of locating the pressure node of the structural vibration and accumulation of microparticles at the centre of the cylindrical tube was found to be similar to the simulation results. The time to accumulate microparticles to a longitudinal streamline at the centre of the tube and the width of the streamline of accumulated microparticles were measured. The effect of concentration of sodium alginate and microparticles in the ink on microparticle accumulation in the tube and the printing structure were studied. The printing capability without and with acoustic excitation was compared statistically. Furthermore, the ability of higher harmonics was also evaluated. Various patterns of microparticles in the printing structure could be controlled by adjusting the excitation frequencies.

### Numerical Simulation

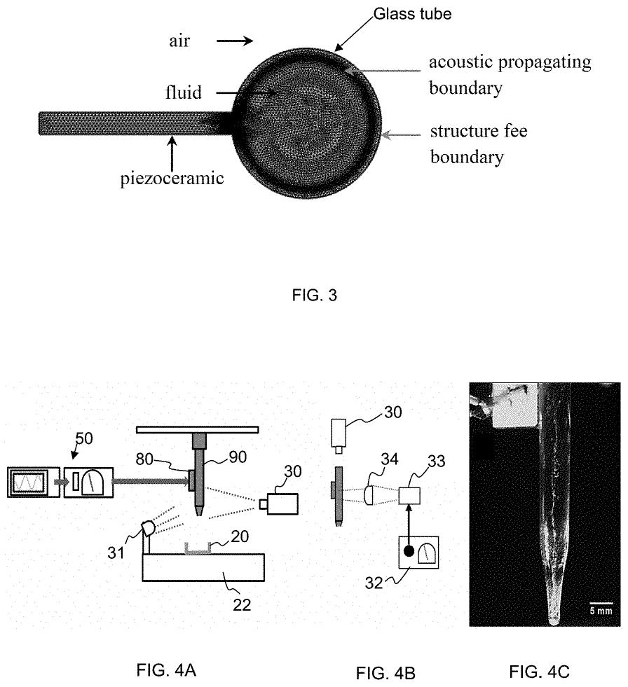

A model was established for numerical simulation using a finite element method (FEM) software (COMSOL 5.2, Stockholm, Sweden). In the model, a plate of piezoceramic (11×11×2 mm³) was attached to the outer side of a cylindrical glass tube having inner and outer diameters of 6.4 mm and 7.0 mm respectively, as shown in FIG. 3. Electrical signals were supplied to the piezoceramic to excite the longitudinal mechanical vibration which is perpendicular to the surface of the glass tube and then coupled into the liquid inside the glass tube. Triangle meshes were used in the FEM, and there were in total 7531 meshes in the domain of the piezoceramic, glass tube, and fluid. The average mesh growth rate was 1.521. The smallest mesh size was 2 μm at the interface between piezoceramic and glass. A total of 124 microparticles in the diameter of 50 μm were distributed uniformly inside the tube initially.

Numerical simulation was carried out using the modules of solid mechanics, electrostatic, acoustics, and particle tracing. Initially, eigenfrequency of the glass tube was calculated to determine the excitation frequency and stress-strain response. The outer boundaries of glass tube were freely bound. Then the electrical signal was applied to the piezoceramic plate in the frequency domain. With the piezoelectric effect, the electricity was converted to the stress and strain in the piezoceramic and then transferred to the glass which was described as the linear elastic material. At the interface between glass and fluid, the mechanical waves propagated into the fluid domain. Trajectories of microparticles in the fluid were calculated in the time domain at a step size of 1 ms. The primary radiation force applied to the microparticles pushes them towards the pressure node under the acoustic excitation. The parameters and governing equations used in this simulation are listed in the Appendix and Table A1 below.

### Experimental Setup

A piezoceramic plate (355, 11×11×2 mm³, APC International, Mackeyville, Pa., USA) 80 was glued (Insta-Flex+, Bob Smith Industries, Atascadero, Calif., USA) to a cylindrical glass tube having a tapered tip 90 (Glass Pasteur Pipet, Corning, N.Y., USA), as shown in FIG. 4(a). A sinusoidal signal at a certain frequency was generated by a function generator (AFG3000, Tektronix, Beaverton, Oreg., USA) and then underwent a power amplifier (240L, ENI, Rochester, NY, USA) 50. The power input to the device was 0.71 W, as measured by an impedance analyser (R3272, Advantest Corp, Tokyo, Japan). To maximize the electrical power transferred to the piezoceramic plate 80, a matching unit was custom built and provided to adjust the output impedance to the power amplifier to around 50Ω. The vibration pattern of the glass tube 90 was measured using a laser Doppler vibrometer (PSV-500, Polytec GmbH, Waldbronn, Germany). Trajectories of microparticles in the ink in the glass tube 90 were observed by an industrial camera 30 (55326, Edmund Industrial Optics, Barrington, N.J., USA) with a 25-mm focal length lens under the illumination of a LED light source 31 (V-LSL666, Valore, Singapore). The ink was printed onto a petri dish 20 on a printing stage 22.

In addition, as shown in FIG. 4(b), cross-sectional images of microparticles in the cylindrical glass tube 90 were captured using a light sheet. A fiber optic illuminator 32 (MI-150, Edmund Optics, N.J., USA) and single branch light line guide 33 (#53-986, Edmund Optics, N.J., USA) were used to produce an intensive flat light. A cylindrical lens 34 with a focal length of 25 mm (LOCPCXB22-25, Lighten Optics, Beijing, China) focused the light beam onto the glass tube 90. The camera 30 was then aligned vertically for photography, Temperatures of the piezoceramic and the glass tube were monitored noninvasively by a laser thermometer (AR320, Arco Science & Technology Ltd, Dongguan, Guangdong, China).

### Printing Evaluation

In bioprinting applications, 1%-4% of sodium alginate, a common hydrogel in the biological studies, in deionized (DI) water is widely used to construct the 3D structure for cells [27, 28]. However, the addition of sodium alginate would increase the viscosity of the medium from 2.54 cPs to 37.5 cPs as measured by a rheometer (DHR-2, TA Instruments, New Castle, Del., USA), which is similar to the previously reported value [29]. Various concentrations (e.g., 0.25%, 0.5%, 1.0%, 1.5%, and 2.0% w/w) of polystyrene microparticles (50 μm in diameter, Phosphorex, Hopkinton, Mass., USA) suspended in the alginate solution (180947, Sigma-Aldrich, St, Louis, Mo., USA) at the concentration of 1%, 2%, 3%, and 4% w/w were used as the printing medium. Prior to each printing, the solution was spun by vortex (Maxi Mix III, Barnstead/Thermolyne, Dubuque, Iowa, USA) and degassed in a vacuum chamber (3608-10E, Thermo Scientific, Waltham, Mass., USA). The ink was printed through an extrusion-based bioprinter (TechnoDigm, Singapore) on a petri dish (4″, Corning, Sigma-Aldrich). The distribution of microparticles in the printed structures was observed under a light microscope (CKX-41, Olympus, Tokyo, Japan) with 4× magnification, and then the captured images were quantitatively analysed using digital processing software (ImageJ, National Institute of Health, Bethesda, Md., USA) and calculation software (Matlab, MathWorks, Natick, Mass., USA).

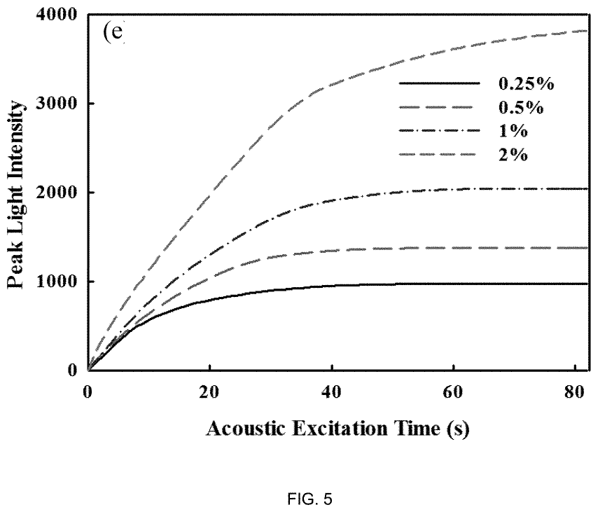

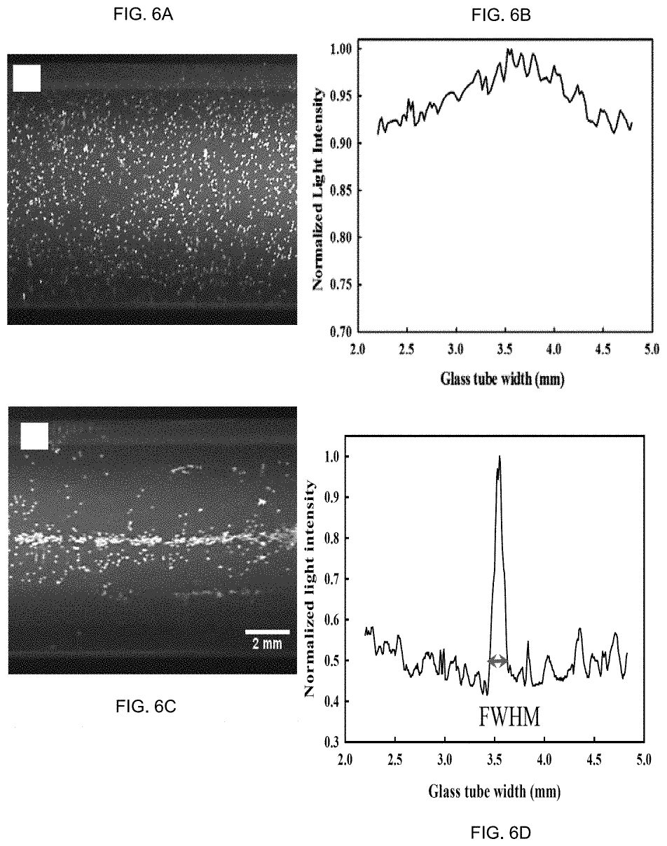

Distribution of microparticles in the glass tube was recorded, and the light intensity across the tube was used to analyse and quantify the characteristics of microparticle accumulation under the acoustic excitation (see FIG. 6 which shows: (a) a representative photo of microparticles in the glass tube with 1% sodium alginate and 0.25% microparticle before acoustic excitation and (b) after acoustic excitation, and the corresponding distributions of the normalized light intensity in (b) and (d)). The change of measured peak light intensity, which is calculated from the obtained RGB colour image as 0.2998+0.587 G+0.114 B, in the course of the acoustic excitation is shown in FIG. 5. When the variation is within ±1% of the maximum value, the microparticle accumulation is assumed to reach its stabilization. The corresponding time is defined as the accumulation time of microparticles. The full width at half maximum (FWHM) of the light intensity distribution at the stabilized stage was used to determine the accumulation width of microparticles, as shown in FIG. 6(d).

In the printing structures, the histogram of deposited microparticles was calculated from the captured images after determining the edge of all microparticles and then fitted using the Gaussian function

$$f ( x ) = \frac{1}{\sqrt{2 π {σ}^{2}}} {e}^{- \frac{{( x - μ )}^{2}}{2 {σ}^{2}}} \qquad ( 1 )$$

where μ is the mean value, σ is the standard deviation. The corresponding FWHVV in the Gaussian curve is given by

FWHW=2σ·\sqrt{2ln2}=2.355·σ (2)

FWHW is used to evaluate the microparticle distribution and compare the performance of acoustic excitation in the printing process. It's well known that 95% of the microparticles are within 2 standard deviations ([μ-2σ, μ+2σ]) in the Gaussian distribution curve.

### Statistical Analysis

Student's t-tests were carried out to determine the statistical significances (95% confidence interval or p-value below 0.05) between different experimental conditions using SigmaPlot (Systat Software, San Jose, Calif., USA). In each group, at least 6 data were included for the analysis.

### Results

### Vibration Modes

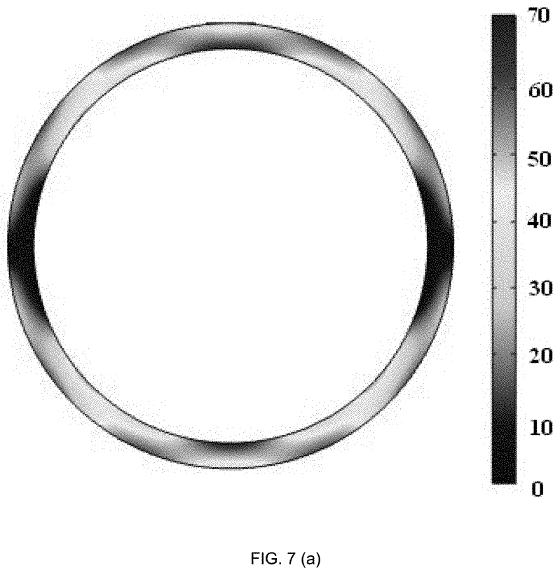

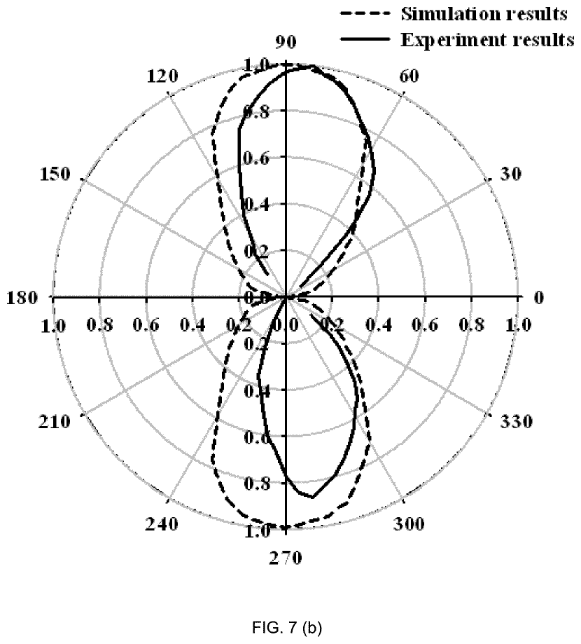

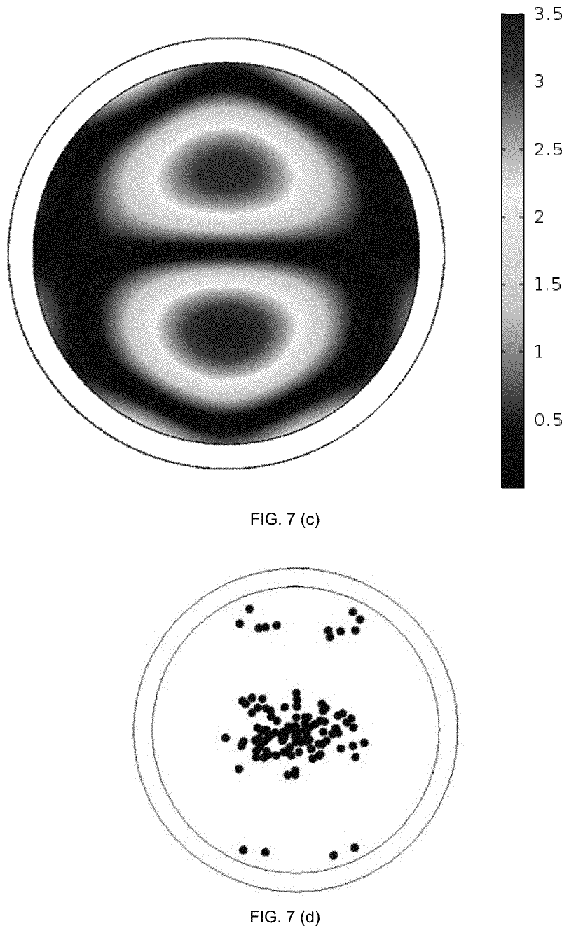

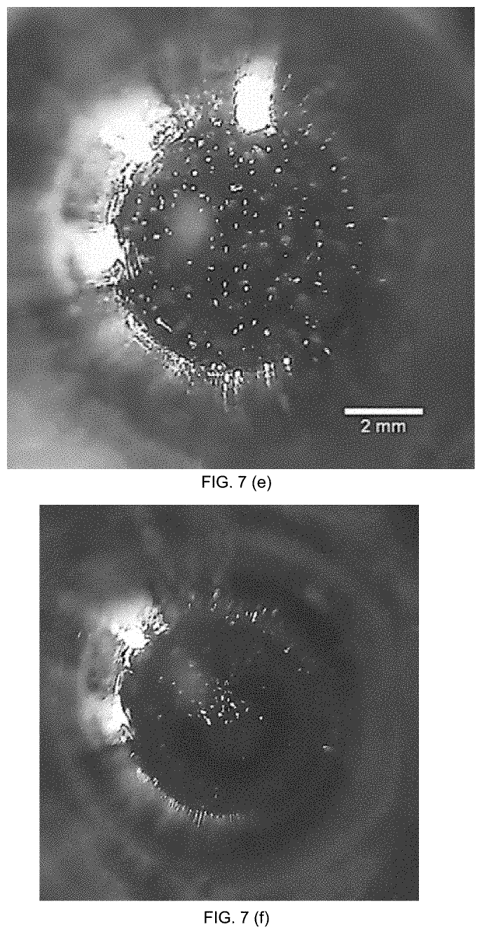

Acoustic excitation aims to accumulate the microparticles in the printing process. The use of fundamental mode which gathers microparticles to the centre of the tube was first investigated (see FIG. 7 which shows: (a) the simulated radial stress of glass tube at the excitation frequency of 168 kHz in kPa, (b) comparison of simulated (172 kHz) and measured (168 kHz) normalized vibration velocity in the polar plot, (c) time-averaged acoustic pressure in kPa at 168 kHz, (d) the locations of 50-μm microparticles after 0.2 seconds of excitation in the simulation, and cross-sectional image of microparticles (e) without and (f) with the acoustic excitation).

The vibration direction is perpendicular to the glass tube. The predicted frequency in the numerical simulation is 168 kHz. The vibration on the surface of the glass tube was measured by the laser Doppler vibrometer and compared to the simulation results. From the scanned contour, there were two regions with high positive vibration velocity was observed at 83.2° (0.070 mm/s) and 277.8° (0.061 mm/s), close to the piezoceramic and its opposite side, which is similar to the previous studies [24]. However, a slight difference of the excitation frequency was observed (168 kHz in the simulation and 172 kHz in the experiment), which may be due to the discrepancies of material properties and inconsistent thickness of the glass tube. In addition, the microparticles assembled due to the secondary Bjerknes force (attractive inter-particle force), gradually grew to lumps, and then moved towards the pressure node in the cross-section of the glass tube [30, 31]. Overall, there was good agreement between the simulation and measurement.

### Accumulation of Microparticles in the Glass Tube

Initially as the microparticles were located randomly in the tube, the light intensity distribution across the tube was quite uniform, whose profile may be associated with the laminar flow for extrusion. Under the acoustic excitation, most of the microparticles gradually moved toward the pressure node at the centre of the tube so that the light intensity distribution had a sharp peak, as shown in FIG. 6(d). However, some microparticles may attach to the inner wall of the glass tube due to surface tension. During the microparticle accumulation, the peak light intensity (mostly at the centre of the glass tube) exponentially rose to its maximum value. With the increase of microparticle concentration, the peak light intensity in the stabilized state increased correspondingly but at a longer microparticle accumulation time.

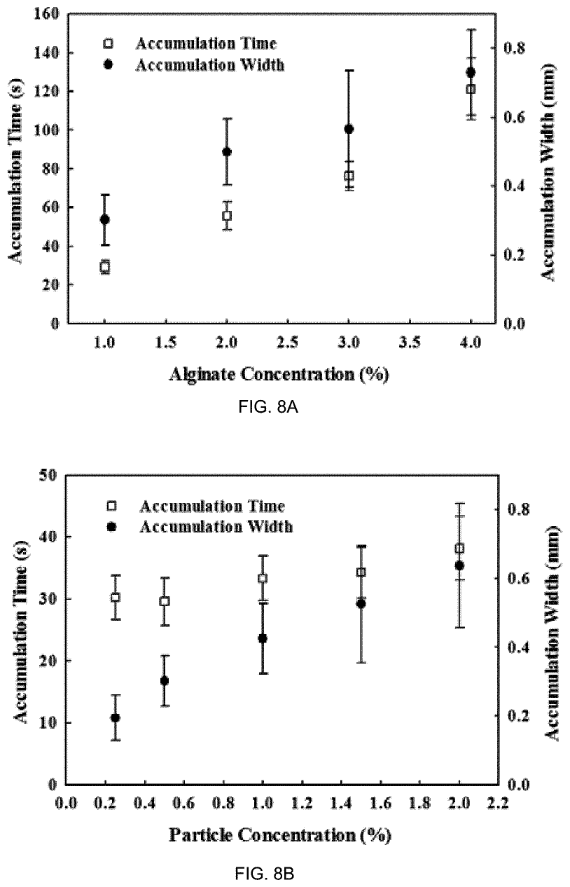

Concentration of alginate and microparticles in the fluid plays a significant role in the hydrodynamics of microparticles, which subsequently determines the efficiency and effectiveness of microparticle accumulation (see FIG. 8 which shows: accumulation time and width of microparticles in the solution with (a) 1%, 2%, 3%, and 4% sodium alginate and 0.25% microparticles and (b) 0.25%, 0.5%, 1.0%, 1.5%, and 2.0% microparticles and 1% sodium alginate (n=6 for each condition). The microparticle accumulation width increased in 3.3 fold from 0.19±0.07 to 0.64±0.18 mm at the microparticle concentration from 0.25% to 2% and 1% alginate in the fluid. The corresponding increase was 2.4 fold from 0.30±0.07 mm to 0.73±0±0.12 mm with the increase of alginate from 1% to 4% and 0.5% microparticles in the fluid. The accumulation time increased almost linearly in 4.1 fold from 29.3±3.5 s to 121.2±16.1 s with the increase of alginate from 1% to 4%. However, there are fewer influences on the accumulation time by the concentration of microparticles than that of alginate. The corresponding value increased slightly in 1.3 fold from 30.3±3.6 s to 38.1±5.2 s with the increase of microparticle concentration from 0.25% to 2.0%. Overall, the accumulation time is more sensitive to the concentration of alginate than that of the microparticle, which may be due to the fluid viscosity.

### Microparticle Distribution in the Printing Structure

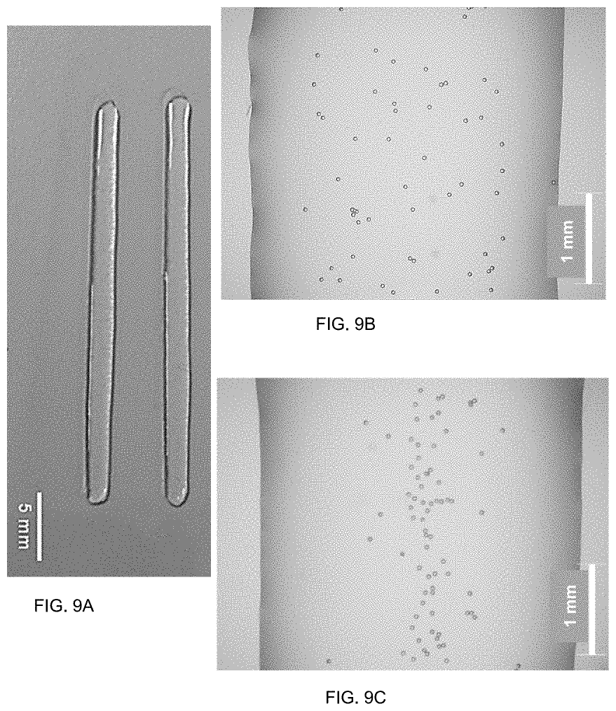

The printing structure by the extrusion-based bioprinter was straight lines on the petri dish. The distribution of microparticles inside the printing structure was observed under the light microscope. It is found that microparticles distributed quite uniformly without an acoustic activation, but mostly at the center after the printing with the acoustic excitation due to the in prior accumulation in the glass tube (see FIG. 9 which shows printing structures with 2% sodium alginate and 0.5% microparticle on the petri dish, and zoomed photos illustrating the distribution of microparticle inside them (b) without and (c) with an acoustic excitation during the bioprinting (scale of 1 mm).).

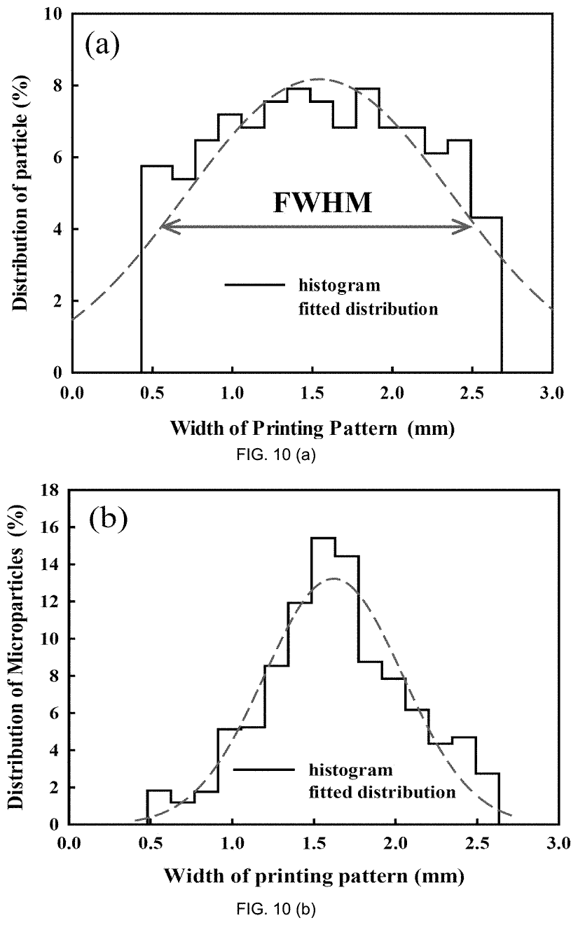

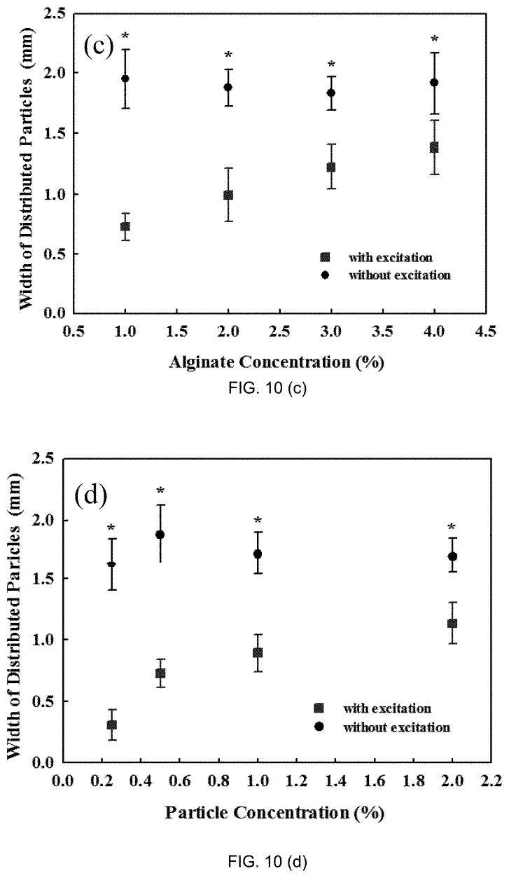

The microparticle distribution in the printing structure was represented in the histogram quantitatively and then fitted by the Gaussian curve to compare the accumulated microparticle widths (see FIG. 10 which shows histogram (solid line) and fitted Gaussian curve (dashed line) of microparticle distribution in the printing structure using the ink with 1% sodium alginate and 0.5% microparticle (a) without and (b) with the acoustic excitation, and comparison of the distributed microparticle width (c) at the various sodium alginate concentration from 1% to 4% and microparticle concentration of 0.5% and (d) at the sodium alginate concentration of 1% and various microparticle concentrations from 0.25% to 2%, *: statistically different between the experimental data without and with the acoustic excitation (p<0.05).),

The acoustic excitation could accumulate the microparticles mostly at the center. The percentage in the three central bins of the histogram was 46.5±3.7%, 41.8±4.1%, and 43.4±4.9% at the alginate concentration of 1% and the microparticle concentration of 0.25%, 0.5%, and 1%, respectively. However, the corresponding value significantly dropped to 32.8±5.2% at 2% microparticle. In comparison, the percentage of accumulated microparticles in the three central bins fairly dropped from 41.8±4.1% to 35.6±5.7% with the increase of 2.0 alginate concentration from 1% to 4% at the microparticle concentration of 0.5%. In comparison to the conventional printing without the acoustic excitation, the values of FWHM were always larger than those of acoustic excitation at all experimental conditions (p<0.05) and increased with the concentration of alginate and microparticles with the acoustic excitation, from 0.31±0.13 mm to 1.13±0.17 mm (3.7 fold) for 0.25% and 2% microparticle and 1% alginate and from 0.73±0.11 mm to 1.39±0.22 mm (1.9 fold) for 1% and 4% alginate and 0.5% microparticle, respectively. The discrepancy between the accumulated microparticle width in the glass tube and printing structure is due to the streamline through the nozzle. Another reason may be the difference between the counted microparticles in the printing structure and the detected light intensity in the glass tube.

### High Orders of Structural Vibration

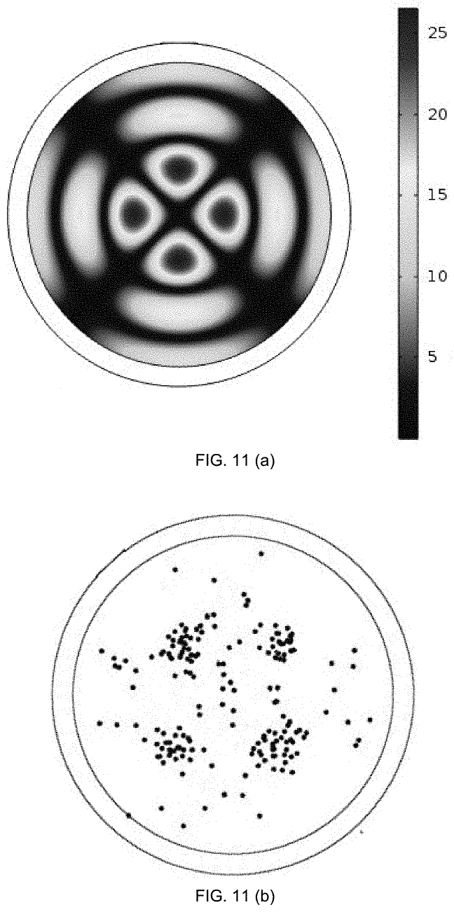

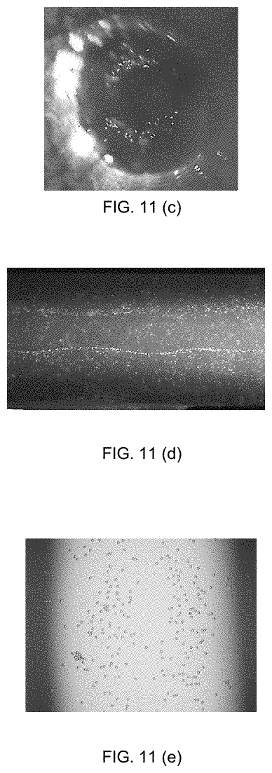

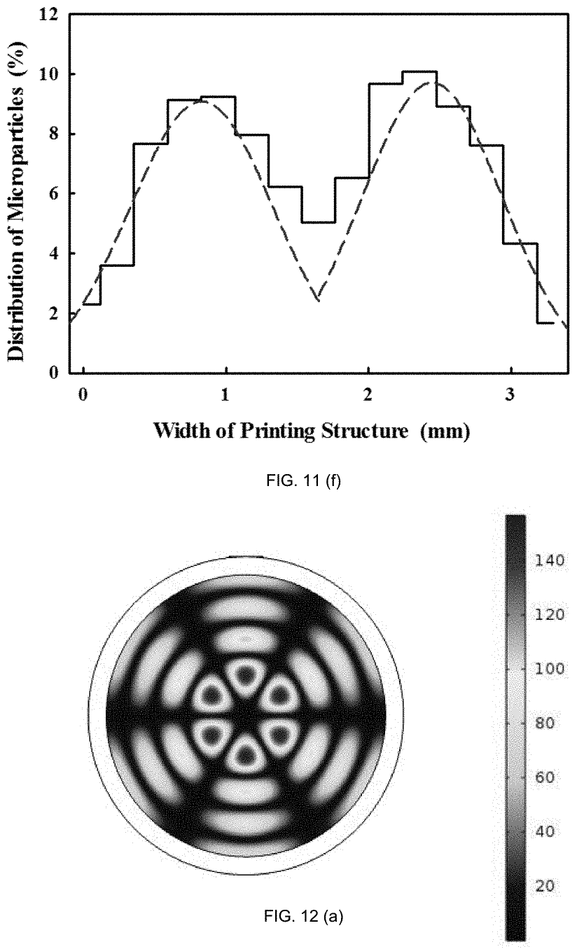

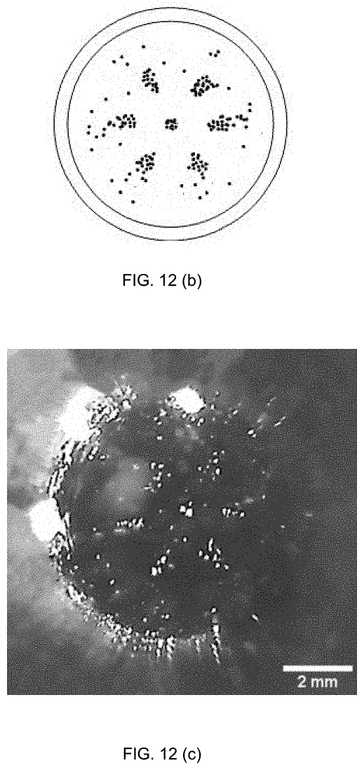

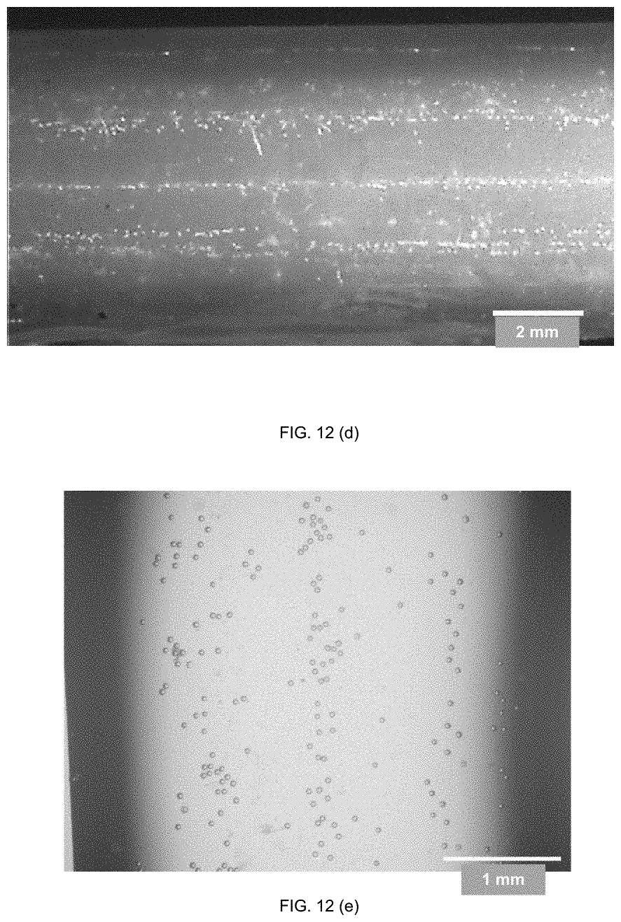

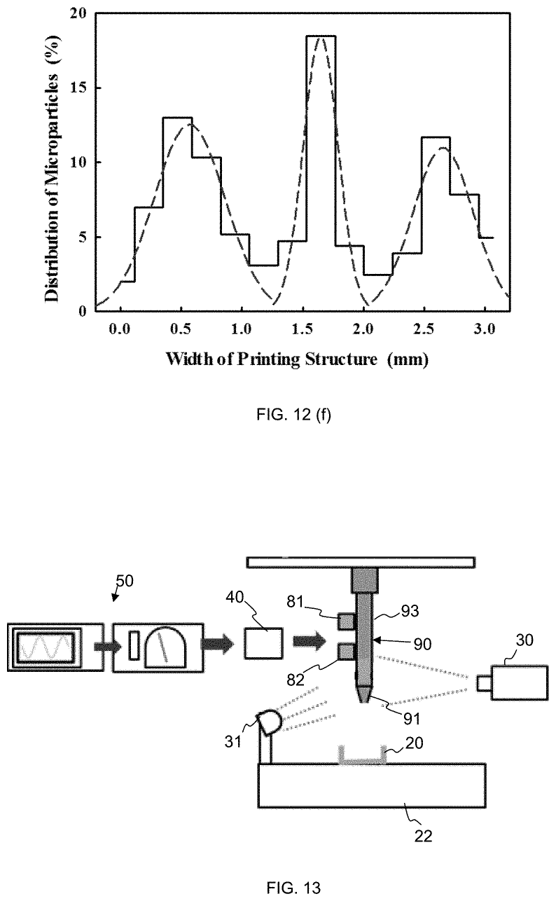

The higher orders of structural vibration were also investigated here. In the numerical simulation, the driving frequencies of two high orders were found to be 393 and 563 kHz. The microparticles will accumulate at the pressure nodes (between the acoustic peaks). At 393 kHz (see FIG. 11 which shows the (a) simulated acoustic pressure field in kPa, and (b) location of accumulated microparticles in the cross-section at 393 kHz, representative photos of accumulated microparticles (c) in the cross-section, (d) along the glass tube, (e) in the printing structure, (f) the histogram and fitted Gaussian curves for each accumulation lines under the acoustic excitation at 385 kHz), there are 4 symmetric beam patterns distributed evenly in the polar coordinate of the average acoustic field and subsequently four accumulation regions in the cross-section of the glass tube. In comparison, there are six symmetric acoustic beams at 563 kHz (see FIG. 12 which shows the (a) simulated acoustic pressure field in kPa, and (b) location of accumulated microparticles in the cross-section at 563 kHz, representative photos of accumulated microparticles (c) in the cross-section, (d) along the glass tube, (e) in the printing structure, (f) the histogram and fitted Gaussian curves for each accumulation lines under the acoustic excitation at 657 kHz). The microparticle accumulation at the centre is more significant than that at 393 kHz. The resonant frequencies of high orders found in the experiment were 385 kHz and 657 kHz, which are slightly different from the simulation as the fundamental mode. The patterns of accumulated microparticles in the cross-section at these two frequencies were found similar to the simulation. There were two accumulated streamlines along the glass tube (˜1.8 mm away from each other with the microparticle accumulation width of 0.70±0.24 mm) although not very straight at 385 kHz. In comparison, three main streamlines were observed (one at the centre with the width of 0.25±0.02 mm, and the other two ˜1.3 mm away from the centre with the width of 0.46±0.12 mm) at 657 kHz. The accumulation times are 24.67±4.2 s and 6.88±1.54 s at 385 kHz and 657 kHz, respectively, with the statistical difference (p<0.05). After the printing, the histogram of microparticle distribution could be fitted by different Gaussian curves at the accumulation positions. The accumulation widths were 1.08±0.34 mm at 385 kHz, and 0.70±0.21 mm (at the side streamlines) and 0.37±0.09 mm (at the central streamline) at 657 kHz.

From the above experimental study, it was found that the structural vibration produced by a piezoceramic plate simply attached to the cylindrical glass tube at a specific frequency could generate pressure node(s) in the cross-section to accumulate the microparticles being dispensed by the tube. Such capability of microparticle accumulation can not only enhance the printing functionality but also reduce the risk of clogging of the nozzle. The motion of microparticles is also dependent on the hydrodynamic properties of streamlines, such as the concentrations of microparticles and sodium alginate. Moreover, the proposed method has the potential in the biological applications. It is noteworthy that this acoustic method is non-invasive and has low heat accumulation, 24-26° C. over 10-15 minutes of acoustic excitation at room temperature around 24° C., which may pave the way to the use of temperature sensitive biological samples in maintaining their morphologies and viabilities. In the near future, the investigation of the motion of cells, their distribution in the printing structure, viability, and proliferation after the printing is required before the practical 3D bioprinting. The cell density and spatial distribution are critical to the morphogenetic development of an engineered tissue, including proliferation, differentiation, and migration [32]. Because of the smaller size of mammalian cells (e.g., 15-30 μm for Hela) and lower stiffness in comparison to the microparticles used here (e.g., ˜120 kPa for Hela and ˜3 GPa for polystyrene) much slower motion speed is expected. In addition, the optimum viscosity of bioinks should be explored, hindering the motion of biological cells at the high medium viscosity while spreading abundantly at the low medium viscosity [33, 34].

The numerical simulation of the excitation frequency and the location of microparticles in the cylindrical tube agreed quite well with the experiment results. When the tube is driven for a long time or at the high power, the accumulation of microparticles will break into discrete nodes, which is mostly due to a weakly coupled standing wave along the cylinder central axis of the glass tube and the formation of vortices until the introduction of thermal convective currents and eventual fluid boiling by the heating of the transducer [35]. The distance between these nodes along the glass tube is moderately constant (˜8 cm) which is closed to the acoustic wavelength (8.63 cm). The formation of these nodes is affected by the tube symmetry, length, and edge conditions. For example, when an O-ring is placed at the nodal position, several neighbouring nodes partially disappear. In contrast, there are no changes when placing the O-ring at the anti-nodal position.

The motion of microparticles is governed by the acoustophoretic (the acoustic radiation force given by Eq. A5) [36, 37], Stokes drag (resistance of microparticles in the medium given by Eq. A4) [38], and hydrodynamic forces [39]. At the high excitation frequency, the higher acoustic radiation force (Eq. A5) could speed up the particle motion and reduce the accumulation width as shown by the high order vibration modes [40, 41]. However, the accumulation pattern will be more complicated and sensitive in the cross-section at the high frequency. For example, there are 8 symmetric acoustic beams in the cross-section polar space at 736 kHz in the simulation, and two acoustic beams at 0° and 180° in the polar coordinate reduce their magnitudes by 20% at 395 kHz (data not included). In contrast, the effect of longitudinal convection streaming and bubble cavitation becomes significant at the low excitation frequency. The medium viscosity increases with the microparticle concentration and subsequently decreases the mobility of microparticles in the fluid [42]. In the highly viscous medium, the increased Stokes drag force pushes the microparticles in the opposite direction of the acoustic radiation force so that following the acoustophoretic force across the fluid streamline or the focusing of microparticles is hindered [8, 43]. As a result, the accumulation is prolonged with the widen accumulation width at the high concentrations of alginate and microparticle [25]. However, the microparticle distribution in the glass tube is not exactly the same as that in the printing structure, which is due to several factors such as the size and shape of the nozzle tip, extrusion pressure, scanning speed of the printer, and the medium viscosity of the ink. Thus, extensive work is required to achieve the desired microparticle accumulation width in the printing structure at each experimental condition. The design of the nozzle tip could be optimized. A short convergent constriction bends the fluid streamline inward suddenly, which might shift the microparticle accumulation toward the center. This streamline bending effect is subsided by using a symmetric long convergence constriction and orifice slightly smaller than the tube [44].

To improve the focusing efficiency and reduce the accumulation time, several strategies are suggested. Firstly, higher excitation power may be applied to the piezoceramic to increase the acoustic pressure and subsequently acoustic radiation force to the microparticles. But the risk of overheating is increased without appropriate thermal diffusion or cooling. Secondly, energy transmission efficiency from the piezoceramic to the glass tube may be increased. Using the piezoceramic plate having a poling direction perpendicular to the glass tube surface or new piezocomposite materials with larger mechanical quality factor and lower dissipation factors may be the solutions. Finally, other vibration modes, such as thickness, thickness shear, longitudinal, cross section shear, and torsional wave, can be explored [45]. By utilizing harmonic flexural vibration of the capillary, subharmonic acoustic pressure standing waves in the fluid can be generated inside the cylindrical tube. Flexural modes are the most important in terms of pressure variation inside the fluid because it enables relatively high normal velocities.

This experimental study demonstrated a practical application of acoustic manipulation to assist additive manufacturing via extrusion-based printing of inks comprising microparticles suspended in a printing medium. The structural vibration of a cylindrical tube with tapered tip was produced, and the acoustic wave was coupled into the ink to accumulate the microparticles to the position of induced pressure node(s). The prediction of the excitation frequency and location of microparticles inside the glass tube in the numerical simulation agrees quite well with the experimental results. Acoustic excitation has the statistically significant effect on the microparticle accumulation in the glass tube. The time and width of microparticle accumulation under the acoustic excitation increase with the concentration of alginate and microparticles in the ink. Although the microparticle concentration has slightly higher effect on the accumulation width than the alginate concentration, its effect on the accumulation time is much less. In the printing structure, the distribution of microparticles could be fitted well in a Gaussian curve, whose FWHM is usually larger than that in the glass tube due to the printing process through the tapered tip. However, the dependence of microparticle accumulation in the printing structure on the microparticle and alginate concentrations is similar to that in the tube. High orders of structural vibration could not only reduce the microparticle accumulation time but also produce more complicated accumulation patterns. Overall, this acoustic technology excitation could improve the patterning of microparticles in the AM and may be applied in the future 3D bioprinting.

### Experimental Study Using Two Transducers

In this experiment using the set-up shown in FIG. 13, the inner diameter of the cylindrical portion 93 of the tubular nozzle 90 was 1.1 mm, and a sinusoidal wave at a driving frequency of 899 kHz and power of 0.6 Watt was used. Two transducers 81, 82 with a multiple-frequency excitation were used to enhance the performance of microparticle accumulation for 3D printing. The transducers 81, 82 may be made of piezoelectric materials. Theoretically, there is no limitation to the manipulation of microparticles/cells in the ink. Preferably, there should be a difference in compressibility and density of the microparticles/cells with respect to the printing medium. A larger difference in these values means a faster response to the manipulation.

### Vibration Modes and Characterisation

Focusing of microparticles into a single stream on the centre of the cylindrical tube 93 is achievable using acoustic excitation. This tube 93 (made of glass) was connected to the tapered tip 91 of the nozzle 90 for printing. The use of fundamental mode was frequency first investigated. The vibration direction is perpendicular to the glass tube 93. The predicted frequency in the numerical simulation is 871 kHz, while the focusing of microparticles was observed at 899 kHz experimentally. A small difference of the excitation frequency (≈3%) might be due to the discrepancies of material properties and inconsistent thickness of the glass tube 93. Additionally, a secondary Bjerknes force could gather microparticles into lumps, and then move them towards the central region of the glass tube 93.

### Distribution of Cells in the Printing Structure

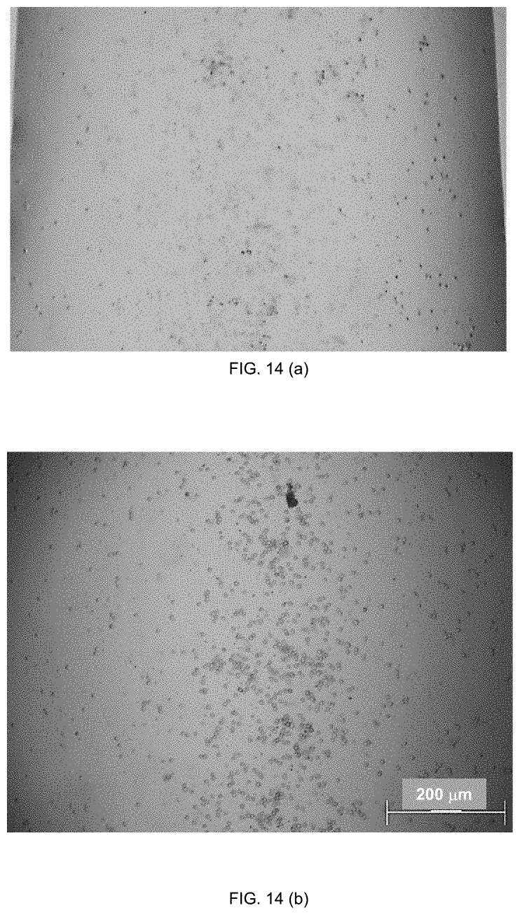

In this experimental study, L929 cells (fibroblast cell line) at an average diameter of 4-7 μm were suspended in a printing medium of 5% gelatine methacrylate (GelMA) (4 million cells per ml) and loaded in the nozzle 90 for printing. Electrical signals at a frequency of 899 kHz and a power of 0.97 Watt were applied to the transducers 81, 82 in order to align the cells toward the centre of the cylindrical tube 93. Afterwards, cells in GelMA were printed out using an extrusion-based printer. The accumulation of cells at the centre of the printing structure was observed under microscope, for cells printed without acoustic excitation and cells printed with acoustic excitation as shown in FIGS. 14(a) and (b) respectively

### Accumulation of Microparticles in the Glass Tube (Clogging of Nozzle)

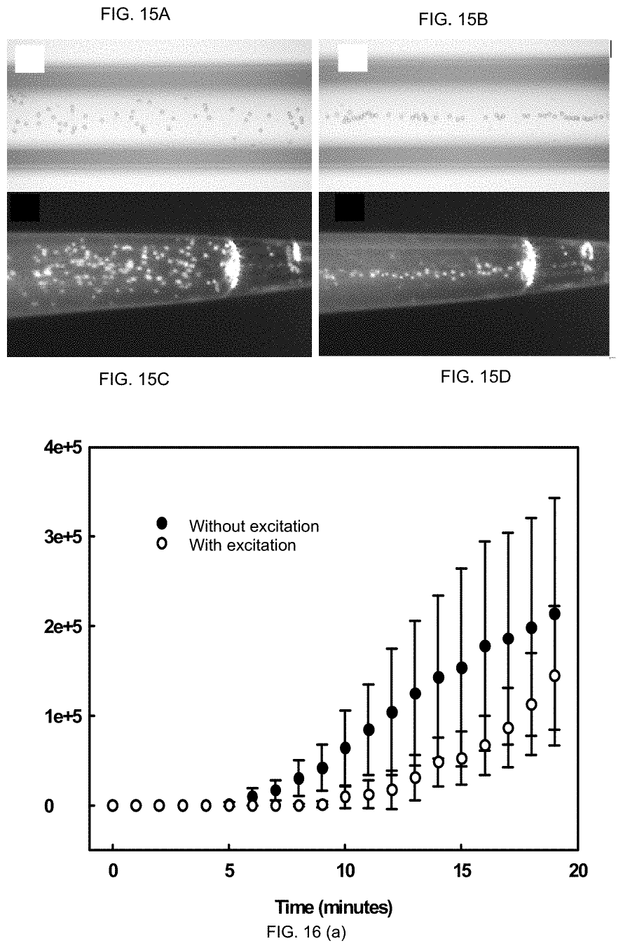

In this experiment, a small diameter nozzle tapered tip 91 (200-250 μm, as shown in FIGS. 15(c) and (d)) and a small cylindrical tube 93 (1.0 mm inner diameter) were used. Thus, driving frequency is increased to 899 kHz in order to match the excitation frequency of a dipole mode. At 899 kHz, microparticles are aligned at the centre of the cylindrical tube 93 as shown in FIG. 15(b). Subsequently, the microparticles were printed out through the nozzle tapered tip 91 as shown in FIG. 15(d). In contrast, no alignment was seen when no acoustic excitation was 2.0 applied, as shown in FIGS. 15(a) and 15(c)

### Reduction of Microparticle Accumulation by Acoustic Excitation

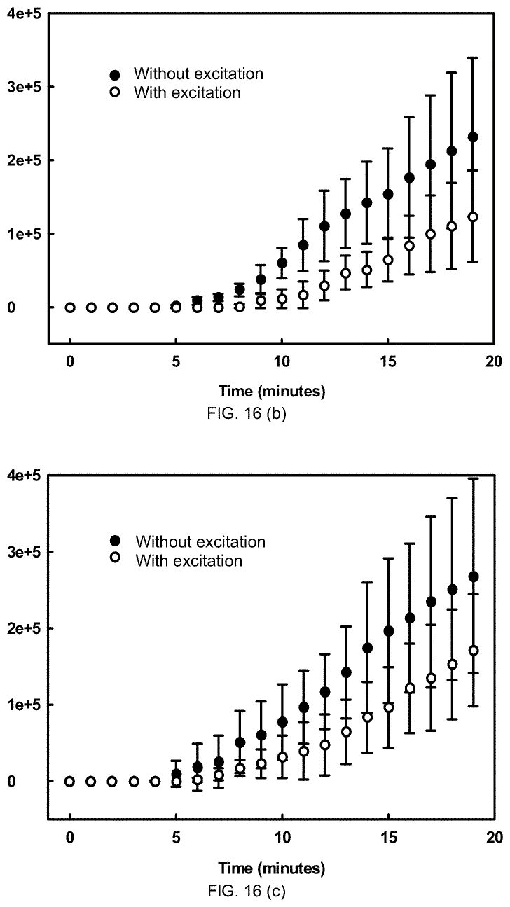

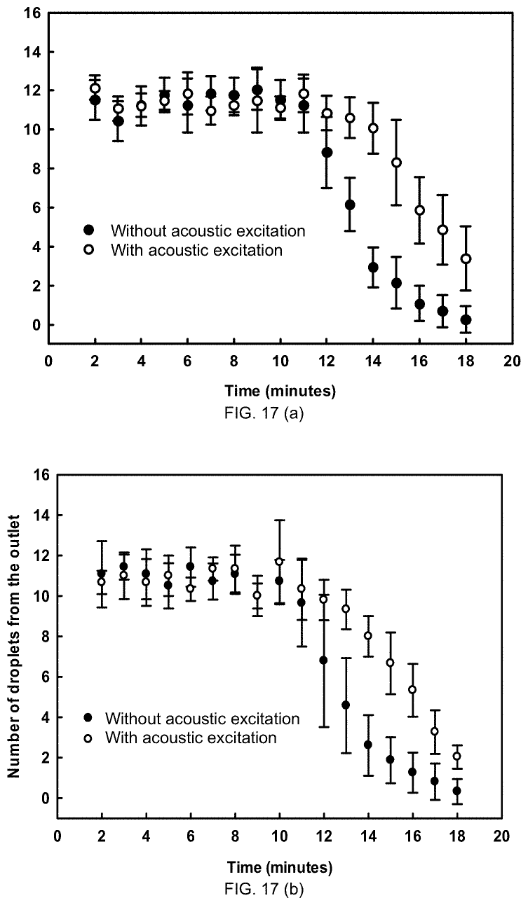

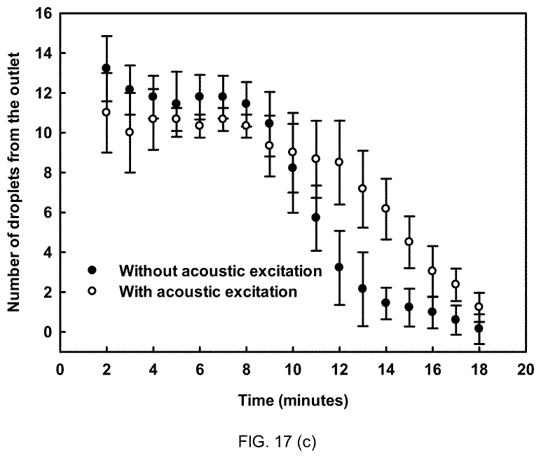

Progressive clogging of the nozzle in prior art apparatus is caused by a consecutive accumulation of microparticles. It slowly obstructs the inner wall of the nozzle channel. Microparticles which travel close to the wall have a high chance of irreversible accumulation on the inner wall. In the present apparatus and method, acoustic excitation focuses microparticles toward the centre of the cylindrical tube 93 and subsequently the centre of the tapered tip 91 of the tubular nozzle 90. Thus, fewer microparticles could accumulate on the surface of the inner wall of the tapered tip 91 of the nozzle 90. With acoustic excitation, the accumulation area at 15 minutes is reduced by 2.90, 2.37 and 2.04 fold for 1%, 2% and 3% respectively of sodium alginate concentration in the fluid, as shown in FIGS. 16(a) to (c). In addition, the outflow discharge is higher by 3.88, 3.56 and 3.68 fold for 1%, 2% and 3% respectively of sodium alginate concentration, as shown in FIGS. 17(a) to (c).

From this experimental study, several observations can be made. Firstly, vibration amplitude of the transducers can be increased by using an impedance matching component 40 which is specially made for individual transducers. Secondly, output power can be slightly increased as physical properties (viscosity, heat conductivity and compressibility) of the printing fluid or medium are different from those of water without a significant effect on acoustic streaming and excessive heat accumulation (heat released from fast fluid velocity). Thirdly, using a plural number of transducers 81, 82 enhances the performance and reduces the acoustic streaming effect.

### Experimental Study of Cell Alignment and Accumulation

This experimental study used the above disclosed apparatus 100 and method 200 to pattern and accumulate C2C12 cells (a skeletal myoblast cell line of Mus musculus [52]) in the nozzle during 3D bioprinting, in which C2C12 cells in 5% GelMA were printed on a 4-inch diameter petri dish. The cell pattern subsequently appears in the printed construct. A structural vibration of the nozzle and patterning of cell accumulation were studied numerically and experimentally. The resonant frequency of structural vibration of the nozzle was numerically and experimentally determined as 871 kHz and 877 kHz, respectively. In the experiment, cells were accumulated at the centre of the nozzle and consequently at the printed construct. The cell distribution of cells printed with acoustic excitation has a significantly lower value of standard deviation (0.27±0.07 mm) than cells printed without the acoustic excitation (0.42±0.12 mm). Furthermore, the acoustic excitation could also be used for patterning C2C12 cells in the 3D printed construct. After printing, the distribution of cells is found to be dense at the centre of the printed construct. Subsequently, it was found that the acoustically-excited cells establish cellular connections and elongate towards the printing direction. Also, immunofluorescent staining indicates a greater alignment/orientation of cell nuclei and myosin heavy chain produced from differentiation of C2C12. Lastly, acoustically-excited C2C12 cells represent a significantly improved orientation of cell nuclei with a high number of oriented cells along the major axis in comparison to the cells without the acoustic excitation, with similarity of the orientation of the acoustically-excited C2C12 muscle fibres with the natural skeletal muscle fibres. This experimental study showed that acoustic excitation during printing of cells using the above disclosed apparatus and method is a convenient, cost-effective and biocompatible method for patterning and accumulation of cells. Also, there are several advantages such as allowing high cell density printing, patterning of cells without nozzle clogging issue. Importantly, using the apparatus 100 and method 200 increases the number of orientated cells along the major axis and enhances cell elongation and differentiation.

Whilst there has been described in the foregoing description exemplary embodiments of the present invention, it will be understood by those skilled in the technology concerned that many variations and combination in details of design, construction and/or operation may be made without departing from the present invention,

### Appendix

The linear behaviour of the piezoelectricateria is presented in the stress-charge and strain-charge forms

T=c_{E}S−e^{T}E, D=eS+ϵ_{S}E (A1)

S=s_{E}T−d^{T}E, D=dT+ϵ_{T}E (A2)

where T is the stress, S is the strain, E is the electric field, D is the electric displacement, c_{E} is the elasticity matrix, e is the coupling matrix, ϵ_{S} is the permittivity matrix. Then the propagation of acoustic wave in the liquid is expressed using Helmholtz equation.

$$∇ \cdot ( - \frac{1}{ρ} ∇ p ) - \frac{{ω}^{2} p}{{ρ}_{c} {c}^{2}} = 0 \qquad ( A 3 )$$

where the acoustic pressure (p) is a harmonic quantity (p=p₀e^{tiωt}), ρ_{c} is the density, ω is the angular frequency, and c is the speed of sound in the fluid.

Because of the different travelling velocities of microparticle and fluid, the Stokes drag force from the fluid acted on the microparticles is commonly described as [17]

F_{Drag}=6πμr(ν_{fluid}−ν_{particle}) (A4)

where r, ν_{medium}, ν_{particle} refer to the radius of the microparticle, velocity of the fluid and the microparticle, respectively.

In the acoustic field, monopole and dipole scattering from oscillation and pulsation of the microparticle result in the acoustic radiation force that is described using the Gauss's theorem [18].

$$\begin{matrix}{F}^{rad} = \frac{4}{3} π {r}^{3} ∇ [ {f}_{mono} \frac{1}{2} {k}_{0} {p}_{prop}^{2} - {f}_{dip} \frac{3}{4} {ρ}_{0} {v}_{prop}^{2} ] & ( A 5 ) \\ {f}_{mono} = 1 - \frac{{k}_{p}}{{k}_{f}} , {f}_{dip} = \frac{{ρ}_{p} - {ρ}_{f}}{{ρ}_{p} + {ρ}_{f / 2}} & ( A 6 )\end{matrix}$$

where, ρₚ and ρ_{f} are the density of particle and fluid, kₚ and k_{f} are the compressibility of particle and fluid, fₘₒₙₒ and f_{dip} are the dimensionless scattering coefficients for monopole and dipole, respectively, and k₀ is the acoustic wave number. In the viscous fluid, Prandtl-Schlichting and acoustic boundary layer could be taken into account by adding the viscosity-dependent correction into the dipole scattering coefficient [19].

$${f}_{dip} = \frac{2 ( 1 - γ ) ( {ρ}_{p} - {ρ}_{0} )}{2 {ρ}_{p} + {ρ}_{0} ( 1 + \frac{δ}{2} [ 1 + i ( 1 + \frac{δ}{r} ) ] df ( \frac{δ}{r} ) )} \qquad ( A 7 )$$

where δ is the distance to the boundary layer, and is the complex unit. The motion of microparticles was governed by Newton's second law.

FEM was used to find the approximate solution of partial differential equations (PDEs). The main components consist of piezoelectric material and cylindrical glass tube filled with fluid. The electrical signal is applied to the piezoceramic plate attached to the glass tube. One side of the piezoceramic was defined as the free boundary and the other side was attached to the glass tube. The boundary of the glass tube was considered as hard wall and assumed to be reflective

$$\vec{n} \cdot ( - \frac{1}{ρ} ∇ p + q ) = 0 \qquad ( A 8 )$$

where n̅ is the normal vector pointing inward the centre of the tube. Hence the acoustic standing waves could be formed in the fluid surround by hard wall.

TABLE A1
Material properties used in the numerical simulation

| medium | parameter | value | |
|---|---|---|---|
| water | density, ρ_{W} | 997 | kg/m³ |
| | speed of sound, C_{W} | 1497 | m/s |
| | viscosity, μ_{W} | 0.890 | mPa · s |
| | compressibility, K_{W} | 448 | TPa⁻¹ |
| microparticle | density, ρ_{W} | 997 | kg/m³ |
| | speed of sound, C_{W} | 1497 | m/s |
| | viscosity, μ_{W} | 0.890 | mPa · s |
| | compressibility, K_{W} | 448 | TPa⁻¹ |
| glass tube | density, ρ | 7600 | kg/m³ |
| | Young's modulus, E | 70 | GPa |
| | Poisson's ratio, V | 0.23 | |
| piezoceramic | density, ρ | 7600 | kg/m³ |
| | speed of shear wave, V_{T} | 2005 | m/s |
| | speed of longitudinal wave, V_{L} | 1700 | m/s |

| | |
|---|---|
| electromechanical coupling | 0.68 and 0.33 |
| factors, k₃₃ and k₃₁ | |

### REFERENCES

[1] L. R. Holmes and J. C. Riddick, “Research summary of an additive manufacturing technology for the fabrication of 3D composites with tailored internal structure,” JOM, vol. 66, pp. 270-274, 2014.

[2] Q. Fu, E. Saiz, and A. P. Tomsia, “Direct ink writing of highly porous and strong glass scaffolds for load-bearing bone defects repair and regeneration,” Acta biomaterialia, vol. 7, pp. 3547-3554, 2011.

[3] A. R. A. Fattah, A. M. Abdalla, S. Mishriki, E. Meleca, F. Geng, S. Ghosh, et al., “Magnetic Printing of a Biosensor: Inexpensive Rapid Sensing To Detect Picomolar Amounts of Antigen with Antibody-Functionalized Carbon Nanotubes,” ACS Applied Materials & Interfaces, vol. 9, pp. 11790-11797, 2017.

[4] K. V. Wong and A. Hernandez, “A review of additive manufacturing,” ISRN Mechanical Engineering, vol. 2012, 2012.

[5] M. Vaezi, H. Seitz, and S. Yang, “A review on 3D micro-additive manufacturing technologies,” The International Journal of Advanced Manufacturing Technology, vol. 67, pp. 1721-1754, 2013.

[6] A. M. R. G. a. L. University. (13 April). The 7 Categories of Additive Manufacturing. Available: http://www.lboro.ac.uk/research/amrg/about/

[7] T. A. Campbell and O. S. Ivanova, “3D printing of multifunctional nanocomposites,” Nano Today, vol. 8, pp. 119-120, 2013.

[8] Y. Sriphutkiat and Y. Zhou, “Particle Accumulation in a Microchannel and Its Reduction by a Standing Surface Acoustic Wave (SSAW),” Sensors, vol. 17, p. 106, 2017.

[9] D. Kokkinis, M. Schaffner, and A. R. Studart, “Multimaterial magnetically assisted 3D printing of composite materials,” Nature communications. vol. 6, 2015.

[10] T. Ahn, H.-J. Kim, J. Lee, D.-G. Choi, J.-Y. Jung, J.-H. Choi, et al., “A facile patterning of silver nanowires using a magnetic printing method,” Nanotechnology, vol. 26, p. 345301, 2015.

[11] L. Wang, F. Li, M. Kuang, M. Gao, J. Wang, Y. Huang, et al., “Interface Manipulation for Printing Three-Dimensional Microstructures Under Magnetic Guiding,” small, vol. 11, pp. 1900-1904, 2015.

[12] A. Nel, T. Xia, L. Mädler, and N. Li, “Toxic potential of materials at the nanolevel,” science, vol. 311, pp. 622-627, 2006.

[13] P. van der Asdonk, S. Kragt, and P. H. Kouwer, “Directing Soft Matter in Water Using Electric Fields,” ACS applied materials & interfaces, vol. 8, pp. 16303-16309, 2016.

[14] G. Kim, D. Moeller, and Y. Shkel, “Orthotropic polymeric composites with microstructure tailored by electric field,” Journal of composite materials, vol. 38, pp. 1895-1909, 2004.

[15] J. Shi, D. Ahmed, X. Mao, S.-C. S. Lin, A. Lawit, and T. J. Huang, “Acoustic tweezers: patterning cells and microparticles using standing surface acoustic waves (SSAW),” Lab on a Chip, vol. 9, pp. 2890-2895, 2009.

[16] X. Ding, J. Shi, S.-C. S. Lin, S. Yazdi, B. Kiraly, and T. J. Huang, “Tunable patterning of microparticles and cells using standing surface acoustic waves,” Lab on a chip, vol. 12, pp. 2491-2497, 2012.

[17] B. Raeymaekers, C. Pantea, and D, N, Sinha, “Manipulation of diamond nanoparticles using bulk acoustic waves,” Journal of Applied Physics, vol. 109, p. 014317, 2011.

[18] P. P. A. Suthanthiraraj, M. E. Piyasena, T. A. Woods, M. A. Naivar, G. P. López, and S. W. Graves, “One-dimensional acoustic standing waves in rectangular channels for flow cytometry,” Methods, vol. 57, pp. 259-271, 2012.

[19] M. E. Piyasena, P. P. Austin Suthanthiraraj, R. W. Applegate Jr, A. M. Goumas, T. A. Woods, G. P. López, et al., “Multinode acoustic focusing for parallel flow cytometry,” Analytical chemistry, vol. 84, pp. 1831-1839, 2012.

[20] T. Franke, S. Braunmüller, L. Schmid, A. Wxforth, and D. Weitz, “Surface acoustic wave actuated cell sorting (SAWACS),” Lab on a Chip, vol. 10, pp. 789-794, 2010.

[21] X. Ding, S.-C. S. Lin, M. I. Lapsley, S. Li, X. Guo, C. Y. Chan, et al., “Standing surface acoustic wave (SSAW) based multichannel cell sorting,” Lab on a Chip, vol. 12, pp. 4228-4231, 2012.

[22] T. M. Llewellyn-Jones, B. W. Drinkwater, and R. S. Trask, “3D printed components with ultrasonically arranged microscale structure,” Smart Materials and Structures, vol. 25, p. 02LT01, 2016.

[23] L. Friedrich, R. Collino, T. Ray, and M. Begley, “Acoustic control of microstructures during direct ink writing of two-phase materials,” Sensors and Actuators A: Physical, 2017.

[24] G. Goddard and G. Kaduchak, “Ultrasonic particle concentration in a line-driven cylindrical tube,” The Journal of the Acoustical Society of America, vol. 117, pp, 3440-3447, 2005.

[25] M. W. Ley and H. Bruus, “Continuum modeling of hydrodynamic particle-particle interactions in microfluidic high-concentration suspensions,” Lab on a Chip, vol. 16, pp. 1178-1188, 2016.

[26] R. Crowson and M. Folkes, “Rheology of short glass fiber-reinforced thermoplastics and its application to injection molding. H. The effect of material parameters,” Polymer Engineering & Science, vol. 20, pp. 934-940, 1980.

[27] K. Y. Lee and D. J. Mooney, “Alginate: properties and biomedical applications,” Progress in polymer science, vol. 37, pp. 106-126, 2012.

[28] J. Sun and H. Tan, “Alginate-based biomaterials for regenerative medicine applications,” Materials, vol. 6, pp. 1285-1309, 2013.

[29] Sigma-Aldrich. Product Specification—Alginic acid sodium salt from brown algae. Available:

http://www.sigmaaldrich.com/catalog/product/sigma/a1112?lang=en&region=SG

[30] A. Garcia-Sabaté, A. Castro, M. Hoyos, and R. González-Cinca, “Experimental study on inter-particle acoustic forces,” The Journal of the Acoustical Society of America, vol. 135, pp. 1056-1063, 2014.

[31] S. Sepehrirahnama, K.-M. Lim, and F. S. Chau, “Numerical study of interparticle radiation force acting on rigid spheres in a standing wave,” The Journal of the Acoustical Society of America, vol. 137, pp. 2614-2622, 2015.

[32] Y. Li, T. Ma, D. A. Kniss, L. C. Lasky, and S. T. Yang, “Effects of filtration seeding on cell density, spatial distribution, and proliferation in nonwoven fibrous matrices,” Biotechnology progress, vol. 17, pp. 935-944, 2001.

[33] S̆. S̆ikalo, H.-D. Wilhelm, I. Roisman, S. Jakirlić, and C. Tropea, “Dynamic contact angle of spreading droplets: Experiments and simulations,” Physics of Fluids, vol. 17, p. 062103, 2005.

[34] A. Yarin, “Drop impact dynamics: splashing, spreading, receding, bouncing . . . ,” Annu. Rev. Fluid Mech., vol. 38, pp. 159-192, 2006.

[35] G. R. Goddard, “Ultrasonic Concentration in a Line-Driven Cylindrical Tube,” Los Alamos National Lab.(LANL), Los Alamos, N.M. (United States) 2004.

[36] P. Glynne-Jones and M. Hill, “Acoustofluidics 23: acoustic manipulation combined with other force fields,” Lab on a Chip, vol. 13, pp. 1003-1010, 2013.

[37] H. Bruus, “Acoustofluidics 7: The acoustic radiation force on small particles,” Lab on a Chip, vol. 12, pp. 1014-1021, 2012.

[38] G. K. Batchelor, An introduction to fluid dynamics: Cambridge university press, 2000.

[39] H. Bruus, “Acoustofluidics 1: Governing equations in microfluidics,” Lab on a Chip, vol. 11, pp. 3742-3751, 2011.

[40] J. Shi, X. Mao, D. Ahmed, A. Colletti, and T. J. Huang, “Focusing microparticles in a microfluidic channel with standing surface acoustic waves (SSAW) ” Lab on a Chip, vol. 8, pp. 221-223, 2008.

[41] J. N, Israelachvili, Intermolecular and surface forces: Academic press, 2015.

[42] A. J. Ladd, “Hydrodynamic transport coefficients of random dispersions of hard spheres,” The Journal of chemical physics, vol. 93, pp. 3484-3494, 1990.

[43] Y. Sriphutkiat and Y. Zhou, “Particle Accumulation in Microchannel and Its Reduction by Surface Acoustic Wave (SAW),” 2016.

[44] J. C. Chow and K. Soda, “Laminar flow in tubes with constriction,” The Physics of Fluids, vol. 15, pp. 1700-1706, 1972.

[45] M. Araz, “Generation Of Sub-Wavelength Acoustic Stationary Waves In Microf uidic Platforms: Theory And Applications To The Control Of Micro-Nanoparticles And Biological Entities,” 2010.

[46] M. Settnes and H. Bruus, “Forces acting on a small particle in an acoustical field in a viscous fluid,” Physical Review E, vol. 85, p. 016327, 2012.

[47] A. Sauret, E. C, Barney, A. Perro, E. Villermaux, H. A. Stone, and E. Dressaire, “Clogging by sieving in microchannels: Application to the detection of contaminants in colloidal suspensions,” Applied Physics Letters, vol. 105, p. 074101, 2014.

[48] H. M. Wyss, D. L. Blair, J. F. Morris, H. A. Stone, and D. A. Weitz, “Mechanism for clogging of microchannels,” Physical review E, vol. 74, p. 061402, 2006.

[49] A. Lee, K. Sudau, K. H. Ahn, S. J. Lee, and N. Willenbacher, “Optimization of experimental parameters to suppress nozzle clogging in inkjet printing,” Industrial & Engineering Chemistry Research, vol. 51, pp. 13195-13204, 2012.

[50] S. Parsa, M. Gupta, F. Loizeau, and K. C. Cheung, “Effects of surfactant and gentle agitation on inkjet dispensing of living cells,” Biofabrication, vol. 2, p. 025003, 2010.

[51] M. J. Rosen and J. T. Kunjappu, Surfactants and interfacial phenomena: John Wiley & Sons, 2012.

[52] D. McMahon, P. Anderson, R. Nassar, J. Bunting, Z. Saba, A. Oakeley, et al., “C2C12 cells: biophysical, biochemical, and immunocytochemical properties,” American Journal of Physiology-Cell Physiology, vol. 266, pp. C1795-C1802, 1994.

1. A three dimensional printing apparatus for three dimensional printing of an ink comprising microparticles suspended in a printing medium, the apparatus comprising:
a tubular nozzle with a tapered tip having an outlet for dispensing the ink therethrough;
a first acoustic transducer provided on the nozzle to produce a first structural vibration in the nozzle at a first frequency; and
a second acoustic transducer provided on the nozzle to produce a second structural vibration in the nozzle at a second frequency, the first frequency being higher than the second frequency;
wherein when the ink is being dispensed through the nozzle, the first structural vibration accumulates microparticles in longitudinal streamlines at pressure nodes created in the printing medium, and the second structural vibration aligns the accumulated microparticles in the longitudinal streamlines towards a single central streamline in the printing medium in the direction of the outlet.

2. The apparatus of claim 1, wherein the first frequency and the second frequency are different multiples of a fundamental frequency.

3. The apparatus of claim 2, wherein the first frequency is a higher order frequency relative to the second frequency.

4. The apparatus of claim 1, wherein the first structural vibration and the second structural vibration are perpendicular to a flow path of the ink in the nozzle.

5. The apparatus of claim 1, wherein the first frequency is a third harmonic and the second frequency is a fundamental frequency.

6. The apparatus of claim 5, wherein the second frequency and the first frequency are supplied to the acoustic transducer at a power ratio of 9 to 1.

7. The apparatus of claim 1, wherein the second acoustic transducer is provided downstream of the first acoustic transducer between the first acoustic transducer and the tapered tip.

8. The apparatus of claim 1, wherein the first acoustic transducer and the second acoustic transducer are collinear on the nozzle.

9. A method of three dimensional printing of an ink comprising microparticles suspended in a printing medium, the method comprising the steps of:
(a) dispensing the ink through an outlet of a tubular nozzle with a tapered tip;
(b) producing a first structural vibration in the nozzle at a first frequency to accumulate microparticles in longitudinal streamlines at pressure nodes created in the printing medium; and
(c) producing a second structural vibration in the nozzle at a second frequency to align the accumulated microparticles in the longitudinal streamlines towards a single central streamline in the printing medium in the direction of the outlet, the first frequency being higher than the second frequency.

10. The method of claim 9, wherein the first frequency and the second frequency are different multiples of a fundamental frequency.

11. The method of claim 9, wherein the first frequency is a higher order frequency relative to the second frequency.

12. The method of claim 9, wherein the first structural vibration and the second structural vibration are perpendicular to a flow path of the ink in the nozzle

13. The method of claim 9, wherein step (b) comprises providing a first acoustic transducer on the nozzle and exciting the first acoustic transducer at the first frequency and wherein step (c) comprises providing a second acoustic transducer on the nozzle and exciting the second acoustic transducer at the second frequency.

14. The method of claim 9, wherein the first frequency is a third harmonic and the second frequency is a fundamental frequency.

15. The method of claim 14, wherein the second frequency and the first frequency are supplied to the acoustic transducer at a power ratio of 9 to 1.
